(19) United States
(12) Patent Application Publication
(10) Pub. No.: US 2017/0138565 A1
(43) Pub. Date: May 18, 2017

(54) LIGHTING DEVICE

(71) Applicant: GL VISION INC., Cheorwon-gun, Gangwor-do (KR)

(72) Inventors: Young Wook KO, Pyeongtaek-si (KR); Eun Mi LEE, Seoul (KR)

(73) Assignee: GL VISION INC., Cheorwon-gun, Gangwon-do (KR)

(21) Appl. No.: 15/309,424

(22) PCT Filed: May 7, 2015
(86) PCT No.: PCT/KR2015/004572

§ 371 Date: Nov. 7, 2016

(30) Foreign Application Priority Data
May 7, 2014 (KR) 10-2014-0054319
May 7, 2014 (KR) 10-2014-0054320

(51) Int. Cl. F21V 7/04; F21V 7/22; F21V 23/02; F21V 15/01; F21K 9/20; F21V 19/00

(52) U.S. Cl. CPC F21V 7/04; F21K 9/20; F21V 19/005; F21V 23/02; F21V 15/01; F21V 7/22; F21V 23/002

(57) ABSTRACT

According to an embodiment, a lighting device includes a light source configured to irradiate light, a reflector configured to reflect the light from the light source, and a supporter disposed at a first end of the reflector and configured to support the light source, wherein the light source irradiates the light toward a second end of the reflector, and a reflection area of the reflector becomes larger from the second end of the reflector to the first end of the reflector.

### CROSS-REFERENCE TO RELATED APPLICATION

This application claims priority to and the benefit of Korean Patent Application No. 10-2014-0054319, and No. 10-2014-0054320 filed on May 5, 2014, the disclosure of which is incorporated herein by reference in its entirety.

### TECHNICAL FIELD

Embodiments relate to a lighting device.

### BACKGROUND ART

An illuminator is a device having a lampshade for efficiently irradiating light emitted from a light source such as a light bulb indoors or outdoors. Generally, efficiency of an illuminator depends largely on reflection efficiency of a lampshade.

A lighting device has conventionally been configured using a fluorescent lamp and a lampshade. However, a fluorescent lamp has problems of high power consumption, a short service life, and heat generation.

Recently, a lighting device using a light emitting diode (LED) has been developed. However, an LED has a problem in that eye strain is caused due to an intense linear propagation of light output from the LED.

### DISCLOSURE

### Technical Problem

Embodiments relate to a lighting device using a light emitting diode (LED).

Embodiments relate to a lighting device capable of reducing glare.

### Technical Solution

According to an embodiment, a lighting device includes a light source configured to irradiate light, a reflector configured to reflect the light from the light source, and a supporter disposed at a first end of the reflector and configured to support the light source, wherein the light source irradiates the light toward a second end of the reflector, and a reflection area of the reflector becomes larger from the second end of the reflector to the first end of the reflector.

### Advantageous Effects

According to an embodiment, a lighting device has a light source disposed at a first end of a reflector, and a reflection area of the reflector becomes larger from a second end of the reflector to the first end of the reflector, thereby preventing light from directly being output and preventing glare.

### DESCRIPTION OF DRAWINGS

FIG. 1 is a perspective view of a lighting device according to a first embodiment.

FIG. 2 is an exploded perspective view of the lighting device according to the first embodiment.

FIG. 3 is a top view illustrating a supporter and a light source according to the first embodiment.

FIG. 4 is a cross-sectional view taken along line A-A′ of FIG. 3.

FIG. 5 is a view illustrating a path of light and a distribution of light in the lighting device according to the first embodiment.

FIGS. 6A, to 6C are top views illustrating a supporter and a light source according to a second embodiment.

FIG. 7 is a perspective view illustrating a reflector according to a third embodiment.

FIG. 8 is a cross-sectional view illustrating a lighting device according to a fourth embodiment.

FIGS. 9A and 9B are cross-sectional views illustrating a lighting device according to a fifth embodiment.

FIG. 10 is a perspective view illustrating a lighting device according to a sixth embodiment.

FIG. 11 is a cross-sectional view illustrating the lighting device according to the sixth embodiment.

### MODES OF THE INVENTION

Hereinafter, specific embodiments of the present invention will be described in detail with reference to the accompanying drawings. However, the spirit of the present invention is not limited to embodiments that are disclosed below, and one of ordinary skill in the art who understands the spirit of the present invention may easily propose other less advanced inventions or other embodiments included within the scope of the spirit of the present invention by adding, changing, or omitting an element within the scope of the same spirit. However, such other inventions or embodiments should also be construed as belonging to the scope of the spirit of the present invention.

A lighting device according to an embodiment includes a light source configured to irradiate light, a reflector configured to reflect light from the light source, and a supporter disposed at a first end of the reflector and configured to support the light source, wherein the light source irradiates light toward a second end of the reflector, and a reflection area of the reflector becomes larger from the second end of the reflector to the first end of the reflector.

The lighting device may include a frame disposed outside the reflector.

A shape of the reflector may correspond to that of an inner side of the frame, and the reflector may be attached to the inner side of the frame.

The reflector may be formed of a reflective material applied to the frame.

The lighting device may further include a power supply configured to supply power, and the power supply may be attached to the frame.

The lighting device may further include a fixer configured to fix the reflector and the supporter.

The lighting device may further include a first fixing hole formed at the reflector and a second fixing hole formed at the supporter, and the fixer may be inserted into the first fixing hole and the second fixing hole.

The lighting device may further include a holder protruding from the supporter, and the first end of the reflector may be inserted into the holder.

The supporter may include an opening configured to determine a circumference of an outputting area through which light is output, and the light source may be disposed on the supporter along the circumference of the outputting area.

The reflector may have a truncated cone shape, a cone shape, or a quadrangular pyramid shape.

The supporter may be formed of metallic materials.

The reflector may be coated with a photocatalyst containing a titanium compound.

The supporter may be attached to the frame by an adhesive.

In addition, like reference numerals will be used to describe like elements having the same functions within the scope of the same spirit illustrated in a drawing of each embodiment.

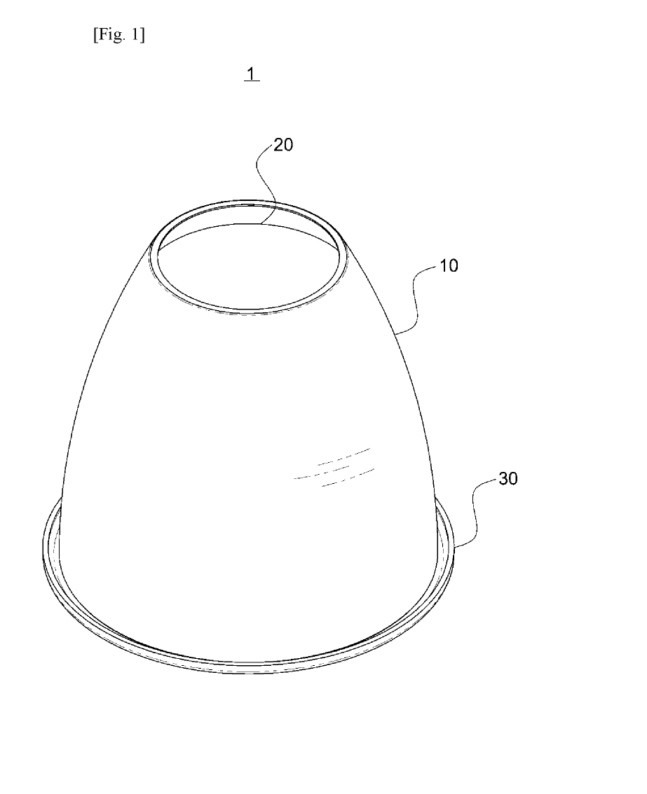

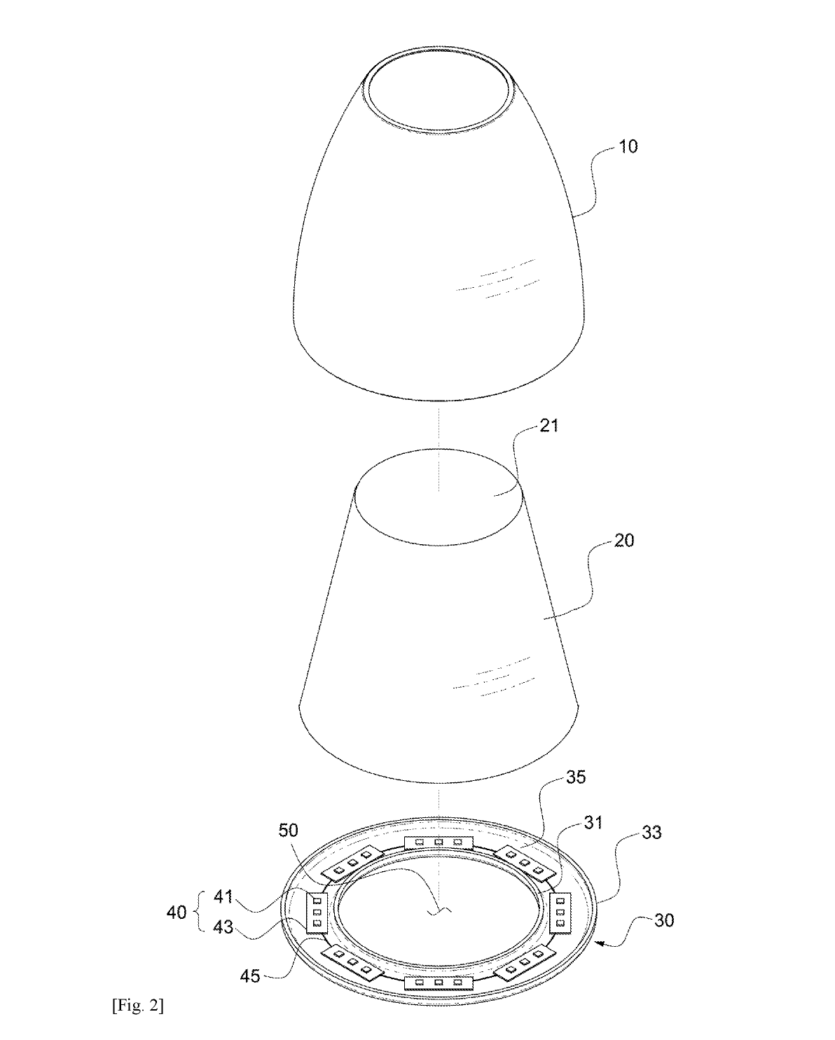

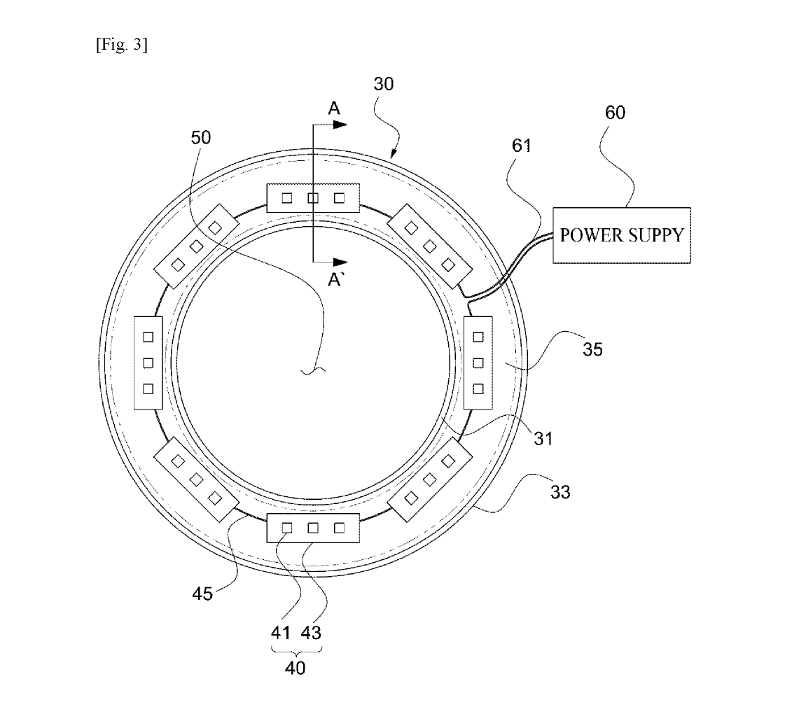

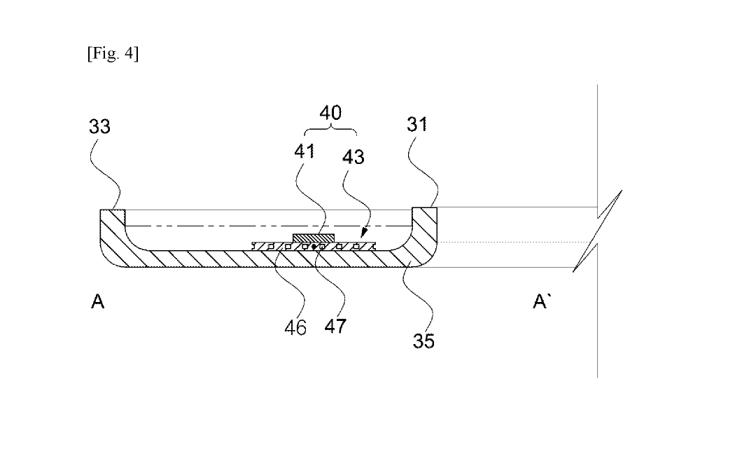

FIG. 1 is a perspective view of a lighting device according to a first embodiment, FIG. 2 is an exploded perspective view of the lighting device according to the first embodiment, FIG. 3 is a top view illustrating a supporter and a light source according to the first embodiment, and FIG. 4 is a cross-sectional view taken along line A-A′ of FIG. 3.

Referring to FIGS. 1 to 4, a lighting device 1 according to the first embodiment may include a frame 10, a reflector 20, and a supporter 30.

The frame 10 may be a mold or a framework configured to form a body of the lighting device 10. The frame 10 may have a hollow truncated cone shape. The frame 10 may have a cone shape with an open bottom surface. The frame 10 may have a cone shape with an open top surface and an open bottom surface.

The frame 10 may have a bell shape with a curved side surface.

Although not illustrated, the frame 10 may further include a heat dissipater. Alternatively, the frame 10 may be formed of a material having high thermal conductivity to facilitate heat dissipation. As a heat dissipating ability of the frame 10 is improved, heat inside the lighting device 1 may be discharged to the outside such that an inner configuration of the lighting device 1 may be prevented from being damaged due to heat.

Although not illustrated, the heat dissipater may be disposed at an outer side of the frame 10, and the heat dissipater may be formed at an inner side of the frame 10. When the heat dissipater is disposed at the inner side of the frame 10, the heat dissipater may be disposed between the frame 10 and the reflector 20.

The reflector 20 may be inserted into an inside of the frame 10. The reflector 20 in a sheet form may be fixed to the inside of the frame 10. A part of the reflector 20 may be attached to the inside of the frame 10 so that the reflector 20 is entirely fixed to the frame 10.

A shape of the reflector 20 may be formed to correspond to that of the frame 10. The reflector 20 may have a hollow truncated cone shape. The reflector 20 may have a truncated cone shape with an open first end. The reflector 20 in the truncated cone shape with the open first end may be defined as a bell shape.

Since the reflector 20 has the truncated cone shape, the first end of the reflector 20 may be formed in a circular shape. An area of the reflector 20 may become narrower from the first end of a second end. That is, when the reflector 20 is divided by a plurality of equally distant parallel lines parallel to the reflector 20, an area of a region defined by adjacent parallel lines may become larger from the second end of the reflector 20 to the first end of the reflector 20. Because the reflector 20 reflects light from the light source, and the reflection area of the reflector 20 becomes larger as the area of the reflector 20 becomes larger, the reflection area of the reflector 20 becomes larger from the second end of the reflector 20 to the first end of the reflector 20.

A flat area 21 may be formed at the reflector 20. The flat area 21 may be connected to the second end of the reflector 20. The flat area 21 may have a circular shape because the flat area 21 is connected to the second end of the reflector 20. The flat area 21 may be a surface parallel to an outputting area 50. The flat area 21 may include the same material as the reflector member 20. The flat area 21 may be integrally formed with the reflector 20.

When the reflector 20 is formed in the sheet form, the reflector 20 may include a resin layer, a foam or filler (a diffusing agent), a metallic layer, and a protective layer. For example, the resin layer may be formed of a material such as polyethylene terephthalate (PET), polycarbonate (PC), photovoltaics (PV), and polypropylene (PP) and may include a foam or organic/inorganic filler such as barium sulfate (BaSO₄) or potassium carbonate (K₂CO₃) therein. A metallic layer formed of aluminum, silver, or the like is formed at a side of the resin layer, and a protective layer for protecting the reflector 20 is formed at a side of the metallic layer.

Examples of an inorganic filler for improving reflectance of the reflector 20 include BaSO₄, calcium sulfate (CaSO₄), magnesium sulfate (MgSO₄), barium carbonate (BaCO₃), calcium carbonate (CaCO₃), K₂CO₃, magnesium chloride (MgCl₂), aluminum hydroxide (Al(OH)₃), magnesium hydroxide (Mg(OH)₂), potassium hydroxide (Cq(OH)₂), titanium dioxide (TiO₂), alumina (Al₂O₃), silica (SiO₂), talc (H₂Mg₃(SiO₃)₄ or Mg₃Si₄O₁₀(OH)₂), and zeolite. Also, the reflector 20 may not include a metallic layer, and an ultraviolet absorption layer (a degradation prevention layer) may be additionally included at the side of the resin layer or inside the resin layer.

The reflector 20 may have a thickness of 0.015 mm to 15 mm. The reflectance of the reflection member 20 may be 60% to 99.8%. Also, according to another embodiment, the reflector 20 may not include a diffusion pattern or filler and may be a sheet having an extremely high reflectance. In this case, optical loss is decreased, and an amount of output light is increased by the high reflectance of the reflector 20.

A photocatalyst for preventing dust adhesion may be applied on a light-reflecting surface of the reflector 20.

The photocatalyst may include a titanium compound expressed by TiOx:D. Here, D refers to a dopant, and the dopant may include nitrogen (N), carbon (C), hydroxide (OH—), iron (Fe), chromium (Cr), cobalt (Co), or vanadium (V). The titanium compound may be TiO₂ or titanium oxynitride (TiON) and may be coated to be hydrophilic using fine particles. The photocatalyst may have a particle diameter of several nanometers (nm) to several hundred nm. For example, the particle diameter of the photocatalyst may be 5 nm to 900 nm.

Also, the photocatalyst may be applied to the reflector 20 by a binder or a solution containing the photocatalyst being applied on a surface of the reflector 20 and dried. The binder or the solution containing the photocatalyst may have a thickness of 0.05 μm to 20 μm after drying.

An electrical property of the titanium compound exhibits a semiconductor property. When an ultraviolet ray having a short wavelength that is 380 nm or smaller or a visible ray having a wavelength of 380 nm to 780 nm is radiated toward the titanium compound, the titanium compound reaches an excited state, exhibits strong oxidizing power, and becomes chemically stable. That is, when the ultraviolet ray or visible ray is absorbed into the titanium compound, an electron and a positive hole are generated at a surface of the titanium compound, and the generated electron and positive hole serve to decompose most harmful materials.

The photocatalyst has a hydrophilic effect and thus has a dustproofing effect. That is, when water is sprayed toward a coated surface of the photocatalyst, the surface exhibits a hydrophilic effect because a contact angle between sprayed water drops and the surface of a base material is decreased. Due to this property, dust adhesion is prevented at the surface.

Also, the photocatalyst has an ability to oxidize and decompose various types of organic materials (carbon compounds). Thus, the photocatalyst decomposes odor-causing materials such as ammonia, hydrogen sulfide, acetaldehyde, trimethylamine, methyl mercaptan, methyl sulfide, dimethyl disulfide, and styrene, thereby having odor-removing, air-purifying, sterilizing, and antibacterial effects.

The photocatalyst may be applied to the surface of the reflector 20 by being sprayed thereon in a liquid state. That is, a user may conveniently apply the photocatalyst onto the surface of the reflector 20 by spraying the photocatalyst in a liquid state on the surface of the reflector 20 using a sprayer.

Also, the photocatalyst may be applied to the surface of the reflector 20 using screen printing, gravure printing, spraying, and roll brushing after spraying.

Screen printing is a printing method in which a liquid that contains photocatalyst is uniformly applied through a fine mesh formed at a printing screen. Gravure printing is a printing method in which a concave roller stained with a liquid that contains a photocatalyst is used to apply the photocatalyst on a surface of the reflector 20. A spraying is a method in which a liquid that contains photocatalyst is sprayed onto the surface. Roll brushing after spraying is a method in which a liquid that contains a photocatalyst is sprayed onto a surface and then applied on the surface by being evenly spread using a roll brush.

According to the embodiment, there is an advantage in that the photocatalyst may be efficiently applied to a large number of reflectors 20 using the printing methods above.

Also, the surface of the reflector 20 may be preprocessed with an organic or inorganic solvent before the photocatalyst is applied to the surface. That is, organic or inorganic contaminants on the surface of the reflector 20 may be cleaned using an organic or inorganic solvent, and then the photocatalyst may be applied to the surface of the reflector 20. Here, the organic or inorganic solvent may be an alkali liquid, such as acetone and alcohol, and neutral detergent.

Also, a coating layer formed of silver nanoparticles or aluminum nanoparticles may be formed at the surface of the reflector 20, and then the photocatalyst may be applied thereon. The coating layer formed of silver nanoparticles or aluminum nanoparticles has an advantage of improving reflection efficiency of a reflection aiding tool.

Also, the photocatalyst may further include an additive configured to adjust viscosity thereof.

The reflector 20 may be formed by being applied inside the frame 10. A material having high reflectance may be applied inside the frame 10, and the material having high reflectance may form the reflector 20.

The supporter 30 may be disposed at a first end of each of the frame 10 and the reflector 20. A shape of the supporter 30 may be formed to correspond to that of the first end of the reflector 20. The shape of the supporter 30 may correspond to that of the first end of the frame 10. Because the first end of each of the frame 10 and the reflector 20 is formed in a circular band shape, the supporter 30 may also be formed in a circular band shape.

A central area of the supporter 30 may be open. The central area of the supporter 30 may be open and have the outputting area 50. That is, the outputting area 50 may be defined by the supporter 30 formed in the circular band shape. A circumference of the outputting area 50 may be determined by the opening of the supporter 30.

The outputting area 50 may be formed in a circular shape. Although not illustrated, an outputting sheet may be attached to the outputting area 50. The outputting sheet may transmit all light heading toward the outputting area 50. The outputting sheet may block foreign materials from entering the lighting device 1. Because the outputting sheet blocks foreign materials from entering the lighting device 1, reflectance of the reflector 20 may be prevented from being decreased by foreign materials.

Although not illustrated, a reflection sheet may be attached to an upper surface of the supporter 30. The reflection sheet attached to the upper surface of the supporter 30 may be the same sheet as the reflector 20. Alternatively, a reflective material may be applied to the upper surface of the supporter 30.

By the reflection sheet being attached to the upper surface of the supporter 30 or the reflective material being applied to the upper surface of the supporter 30, light heading toward the supporter 30 may be reflected toward the reflector 20 and emitted through the outputting area 50. In this way, an amount of light of the lighting device 10 is increased, and power consumption may be reduced with respect to the same amount of light.

Although not illustrated, the supporter 30 may further include a heat dissipater. Alternatively, the supporter 30 may be formed of a material having high thermal conductivity to facilitate heat dissipation. The supporter 30 may be formed of a metallic material having high thermal conductivity. As a heat dissipating ability of the supporter 30 is improved, heat inside the lighting device 1 may be discharged to the outside so that an inner configuration of the lighting device 1 may be prevented from being damaged due to heat.

The supporter 30 may include a first protruding area 31, a second protruding area 33, and a supporting area 35. The first protruding area 31 may protrude from an inside of the supporter 30 toward the frame 10. The second protruding area 33 may protrude from an outside of the supporter 30 toward the frame 10.

The supporting area 35 may connect the first protruding area 31 to the second protruding area 33. That is, the first protruding area 31 and the second protruding area 33 may be formed to respectively protrude from both side areas of the supporting area 35 toward the frame 10. The first protruding area 31, the second protruding area 33, and the supporting area 35 may be integrally formed. The supporting area 35 may support a light source 40.

The first protruding area 31 may be disposed between the supporting area 35 and the outputting area 50. The first protruding area 31 may block light directly radiated from the light source 40 toward the outputting area 50 by being disposed between the supporting area 35 and the outputting area 50. That is, the first protruding area 31 prevents light from the light source 40 from being emitted through the outputting area 50 without a process of being reflected by the reflector 20 so that glare at a particular angle is prevented.

Since the first protruding area 31 and the second protruding area 33 are formed to protrude from both of the side areas of the supporting area 35, movement of the frame 10 and the reflector 20 in a horizontal direction may be prevented. The first protruding area 31 and the second protruding area 33 prevent movement of the frame 10 and the reflector 20 in the horizontal direction so that stability of the lighting device 1 is improved. Also, the first protruding area 31 and the second protruding area 33 may prevent movement of the light source 40 in the horizontal direction so that stability of the lighting device 1 is improved.

The light source 40 may be disposed on the supporter 30. The light source 40 may be disposed on the supporting area 35 of the supporter 30. The light source 40 may be disposed to correspond to the shape of the supporter 30. The light source 40 may be disposed in a shape corresponding to that of the first end of the reflector 20. The light source 40 may be disposed in a circular band shape. The light source 40 may be disposed in a shape that surrounds the outputting area 50. The light source 40 may be disposed in a closed loop shape that surrounds the outputting area 50. The light source 40 may be disposed along the circumference of the outputting area 50.

The light source 40 may include a plurality of light-emitting diodes (LEDs) 41 and a plurality of printed circuit boards (PCBs) 43.

The LEDs 41 may be LEDs or organic LEDs (OLEDs).

The LEDs 41 may be disposed on the PCBs 43. The LEDs 41 may be attached to a surface of the PCBs 43. The LEDs 41 may be mounted on the PCBs 43. The LEDs 41 may be mounted on the PCBs 43 in the form of a package or may be mounted on the PCBs 43 in the form of a chip-on-board (COB).

The plurality of LEDs 41 may be disposed to correspond to the shape of the supporter 30. The plurality of LEDs 41 may be disposed in a shape corresponding to that of the first end of the reflector 20. The plurality of LEDs 41 may be disposed in a circular band shape. The plurality of LEDs 41 may be disposed in a shape that surrounds the outputting area 50. The plurality of LEDs 41 may be disposed in a closed loop shape that surrounds the outputting area 50. The plurality of LEDs 41 may be disposed along a circumference of the outputting area 50.

The plurality of LEDs 41 may be disposed on the plurality of PCBs 43. A plurality of LEDs 41 may be mounted on a single PCB 43. Each of the PCBs 43 on which the plurality of LEDs 41 are mounted may be electrically connected to each other through connecting wires 45.

The plurality of LEDs 41 may receive power required to operate the LEDs 41 through a power supply 60. The power supply 60 is connected to the PCBs 43 via a power supply wire 61 to transmit power to the PCBs 43. The PCBs 43 that receive power from the power supply 60 simultaneously supply power to the LEDs 41 mounted thereon and transmit power to adjacent PCBs 43 through the connecting wires 45. The adjacent PCBs 43 also simultaneously supply power to the LEDs 41 mounted thereon and transmit power to other PCBs 43 through the connecting wires 45. By repeating the above, power is applied to the plurality of LEDs 41, and all of the LEDs 41 emit light.

The power supply 60 may include an alternating current (AC)-to-direct current (DC) converter (ADC) configured to convert AC into DC. The power supply 60 may convert AC power to DC power and transmit the DC power to the PCBs 43. The power supply 60 may also reduce voltage of the converted DC power and transmit the DC power to the PCBs 43.

The power supply 60 may be disposed outside the lighting device 1. Alternatively, the power supply 60 may be disposed inside the light device 1. Although not illustrated, when the power supply 60 is disposed inside the lighting device 1, the power supply 60 may be mounted in the form of a chip on at least one of the plurality of PCBs 43.

When the power supply 60 includes only an ADC function, a separate DC-DC converter may be mounted on the PCBs 43. The DC-DC converter may convert a power supply voltage received from the power supply 60 to correspond to a driving voltage of the LEDs 41 and transmit the converted voltage to the LEDs 41 and adjacent PCBs 43.

Because the power supply 60 is mounted on the PCBs 43, the lighting device 1 may operate and be integrally installed without a separate power supply 60 such that installation and transportation of the lighting device 1 is eased.

The PCBs 43 may include a metallic material. The PCBs 43 may be metal PCBs including a material such as Al and copper (Cu). The PCBs 43 may be FR1, FR4, and CEM1 PCBs. The PCBs may include epoxy or phenol.

Also, the PCBs 43 may be flexible PCBs that are bendable by external force.

The PCBs 43 may include a filler 46 and a heat dissipater 47.

The filler 46 may be an area which is a mold or a framework of the PCBs 43 and may be an area that is filled with the metallic material. The heat dissipater 47 may be an area that is not filled with the metallic material.

The heat dissipater 47 may be a hollow space that is not filled with the metallic material. The heat dissipater 47 may be disposed at an inside of each of the PCBs 43. The heat dissipater 47 may also be formed along side surfaces of the PCBs 43. An area of the filler 46 that comes into contact with the outside may increase due to the heat dissipater 47, and heat generated by the LEDs 41 and the PCBs 43 may be easily discharged to the outside as a result. Accordingly, failure of the LEDs 41 and the PCBs 43 due to heat may be reduced.

Also, heat from the LEDs 41 may be transmitted to the supporter 30 via the PCBs 43, and the supporter 30 having high thermal conductivity may discharge the heat to the outside to reduce damage to the LEDs 41 and the PCBs 43 due to heat.

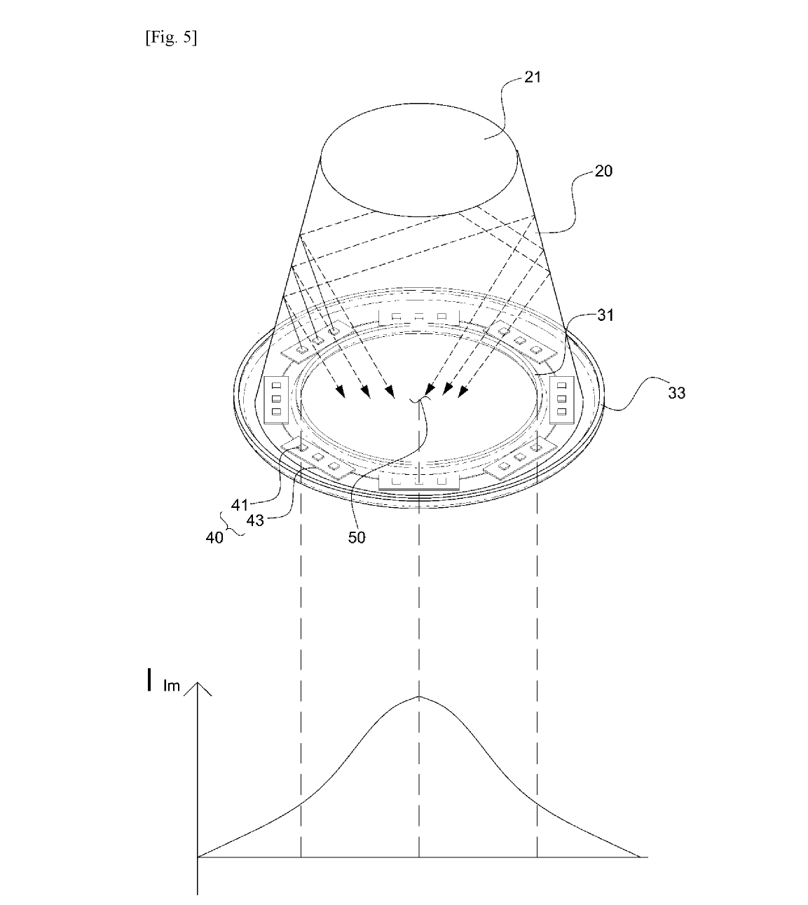

FIG. 5 is a view illustrating a path of light and a distribution of light in the lighting device according to the first embodiment.

Referring to FIG. 5, in the lighting device 1 according to the first embodiment, the plurality of LEDs 41 emit light toward the reflector 20 within a predetermined angle range. The light emitted from the plurality of LEDs 41 is reflected by the reflector 20 one or more times and is output through the outputting area 50.

For example, light incident with a high angle of incidence on the reflector 20 may be output through the outputting area 50 after being reflected once, and light incident with low angle of incidence on the reflector 20 may be output through the outputting area 50 after being reflected two or more times.

Because the reflector 20 may have a diffuse reflection property, the light output from the LEDs 41 may be output through the outputting area 50 after being reflected by a certain number of times that does not depend on an angle of incidence on the reflector 20.

Because the reflector 20 has a reflection area that becomes smaller from the first end adjacent to the light source 40 to the second end spaced apart from the light source 40, light is output through the outputting area 50 by being condensed at a predetermined portion. Also, the outputting area 50 may output uniform light due to a change in the reflection area. When this is viewed in terms of luminous flux, light output through the outputting area 50 follows Gaussian distribution. That is, light output through the outputting area 50 follows Gaussian distribution in which light having the highest luminous flux is output from the center of the outputting area 50 and the luminous flux decreases toward the supporter 30.

Light having an angle of incidence heading toward the outputting area 50 among the light output from the LEDs 41 may be blocked by the first protruding area 31. Since the first protruding area 31 blocks light output from the LEDs 41 that is not reflected toward the outputting area 50, the lighting device 1 may output uniform light.

Due to the presence of the flat area 21, the number of times which light output from the LEDs 41 is reflected may be increased. A distribution range of light output through the outputting area 50 becomes larger due to the increase in the number of times which the light output from the LEDs 41 is reflected.

Also, an output angle of light output through the outputting area 50 approaches the supporter 30 as a distance between the flat area 21 and the outputting area 50 decreases. Consequently, the distribution range of light output through the outputting area 50 may be widened by decreasing the distance between the flat area 21 and the outputting area 50.

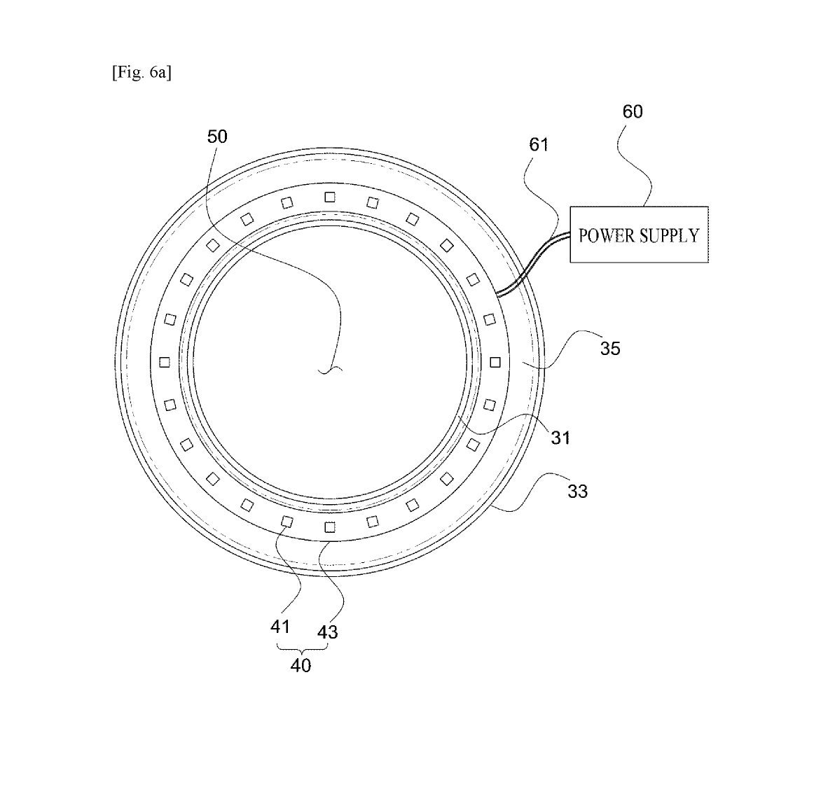

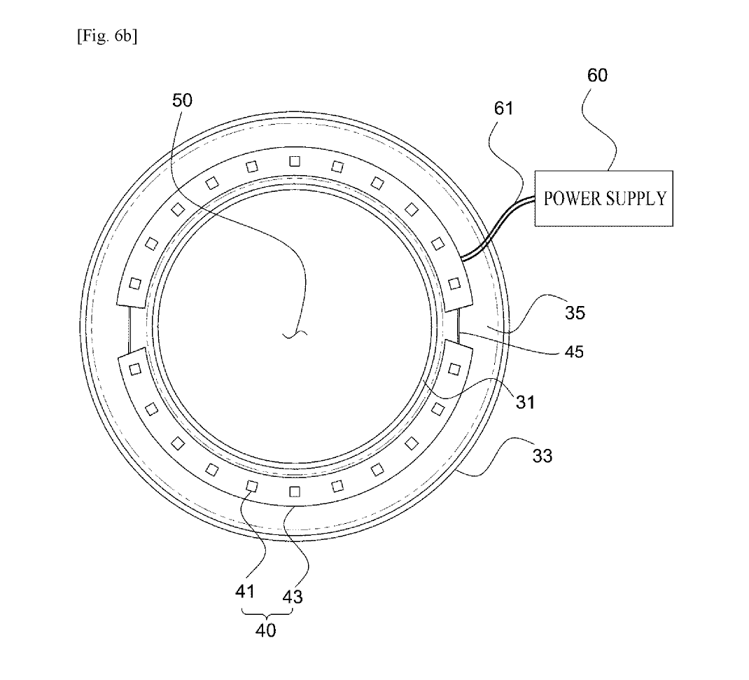

FIGS. 6A, to 6C are top views illustrating a supporter and a light source according to a second embodiment.

Comparing the second embodiment to the first embodiment, only a shape of PCBs is different and the remaining configurations are the same as those in the first embodiment. Consequently, when describing the second embodiment, the same reference numerals will be given to configurations overlapping with the first embodiment, and detailed descriptions thereof will be omitted.

Referring to FIG. 6A, the supporter 30 according to the second embodiment may be formed in a circular band shape with an open central area. The opening of the supporter 30 may determine a circumference of the outputting area 50.

The supporter 30 may include the first protruding area 31, the second protruding area 33, and the supporting area 35. The first protruding area 31 may protrude from an inside of the supporter 30 toward the frame 10. The second protruding area 33 may protrude from an outside of the supporter 30 toward the frame 10.

The light source 40 may be disposed on the supporter 30. The light source 40 may be disposed on the supporting area 35 of the supporter 30. The light source 40 may be disposed to correspond to a shape of the supporter 30. The light source 40 may be disposed in a shape corresponding to that of the first end of the reflector 20. The light source 40 may be disposed in a circular band shape. The light source 40 may be disposed in a shape that surrounds the outputting area 50. The light source 40 may be disposed in a closed loop shape that surrounds the outputting area 50. The light source 40 may be disposed along a circumference of the outputting area 50.

The light source 40 may include a plurality of LEDs 41 and a PCB 43.

The plurality of LEDs 41 may be mounted on a single PCB 43. The PCB 43 may have a shape corresponding to that of the supporter 30. The PCB 43 may be formed in a shape corresponding to that of the supporting area 35. The PCB 43 may be formed in a circular band shape that surrounds the outputting area 50.

The plurality of LEDs 41 may be mounted on the PCB 43 while being spaced apart from each other at predetermined intervals. By mounting the plurality of LEDs 41 on the single PCB 43 as in the second embodiment, failure due to shorting of the connecting wires 45 may be prevented.

Also, by forming the PCB 43 with a size and shape corresponding to those of the supporting area 35, the PCB 43 may be firmly fixed by the first protruding area 31 and the second protruding area 33. Thus, deviation of the PCB 43 due to an external impact may be prevented and reliability of resisting an impact may be improved.

A lighting device 1 according to the second embodiment may include a plurality of PCBs 43 as illustrated in FIGS. 6B and 6C.

The plurality of PCBs 43 may have the same curvature as the outputting area 50 and a boundary of the supporter 30. The plurality of LEDs 41 may be mounted on each of the plurality of PCBs 43.

Adjacent PCBs 43 may be electrically connected to each other by the connecting wires 45. The number of the connecting wires 45 may correspond to the number of the PCBs 43.

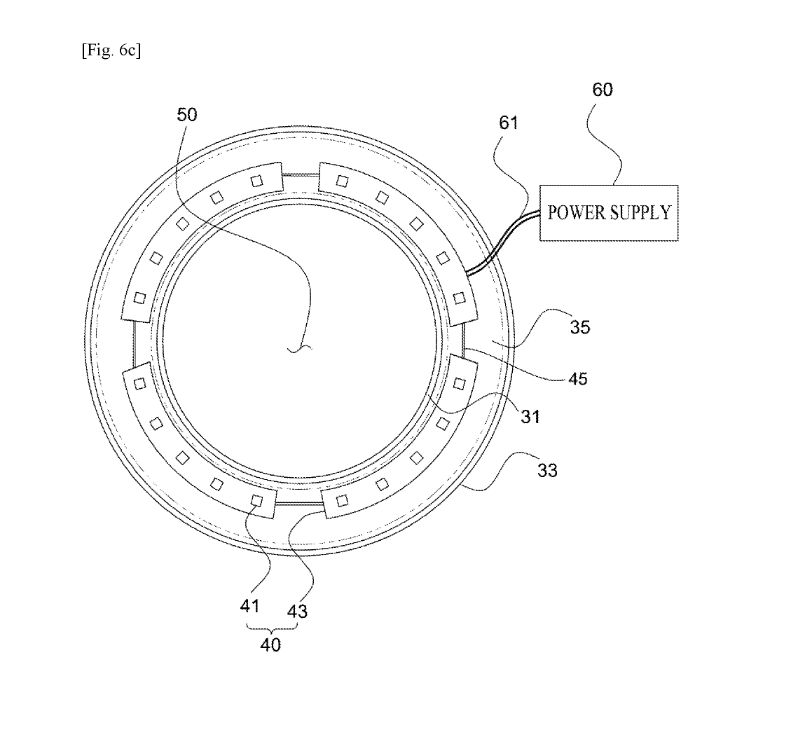

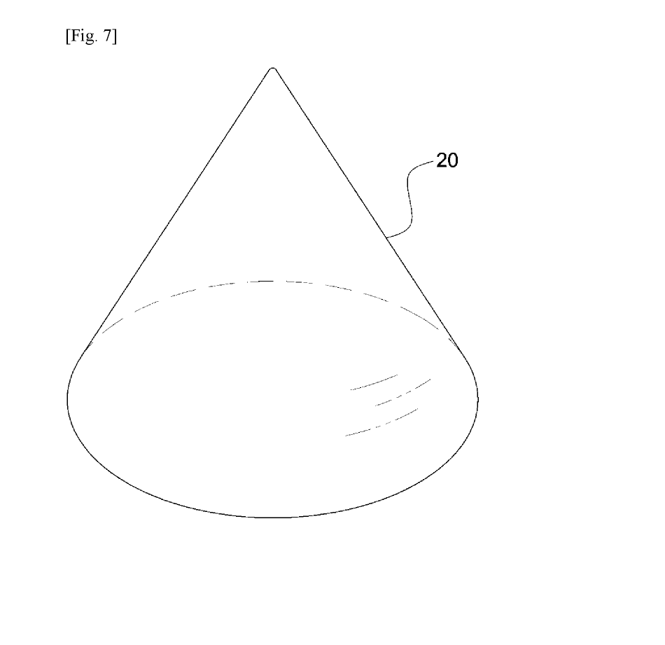

FIG. 7 is a perspective view illustrating a reflector according to a third embodiment.

Comparing the third embodiment to the first embodiment, only a shape of the reflector is different and the remaining configurations are the same as those in the first embodiment. Consequently, when describing the lighting device according to the third embodiment, the same reference numerals will be given to configurations overlapping with the first embodiment, and detailed descriptions thereof will be omitted.

Referring to FIG. 7, a lighting device 1 according to the third embodiment includes a reflector 20.

The reflector 20 may be inserted inside the frame 10.

The reflector 20 may be formed in a hollow cone shape. The reflector 20 may be formed in a cone shape with an open first end. Because the reflector 20 is formed in a cone shape, the first end of the reflector 20 may be formed in a circular shape.

An area of the reflector 20 may become smaller from the first end of the reflector 20 to the second end of the reflector 20. That is, when the reflector 20 is divided by a plurality of equally distant parallel lines parallel to the reflector 20, an area of a region defined by adjacent parallel lines may become larger from the second end of the reflector 20 to the first end of the reflector 20.

Because the reflector 20 reflects light from the light source 40, and the reflection area of the reflector 20 becomes larger as the area of the reflector 20 becomes larger, the reflection area of the reflector 20 becomes larger from the second end of the reflector 20 to the first end of the reflector 20.

The reflector 20 may be in a sheet form or may be formed by a reflective material being applied to the frame 10. A shape of the frame 10 may correspond to the shape of the reflector 20. When the reflector 20 is formed by the reflective material being applied to the frame 10, the reflector 20 may be formed in a shape corresponding to the frame 10.

Because the reflector 20 is formed in a cone shape in the third embodiment, a light concentration rate may be increased compared to the first embodiment in which the reflector 20 is formed in a truncated cone shape. That is, by forming the reflector 20 in a cone shape, higher luminous flux compared to the first embodiment is output to the center of the outputting area 50, and a luminous flux reduction rate increases more toward the supporter 30 compared to the first embodiment. The reflector 20 in the cone shape may be used in an environment such as a factory requiring a high light concentration rate.

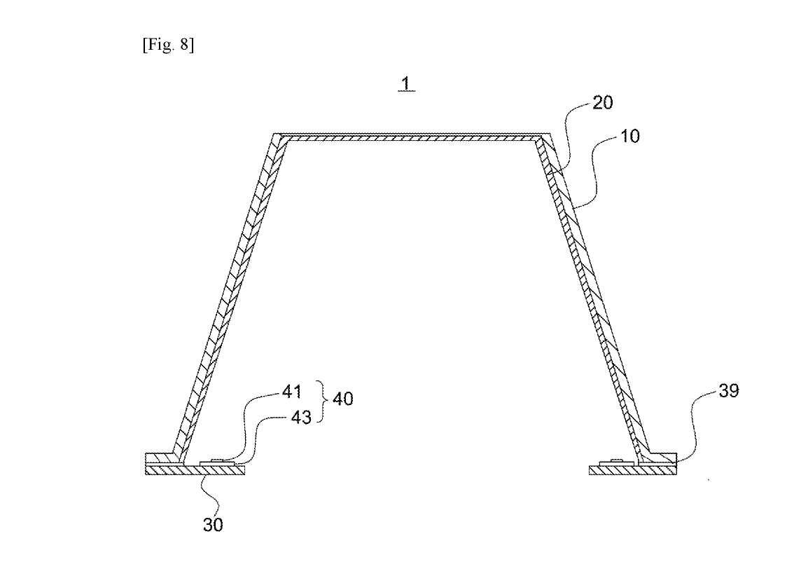

FIG. 8 is a cross-sectional view illustrating a lighting device according to a fourth embodiment.

Comparing the lighting device according to the fourth embodiment to that according to the first embodiment, only a relation between a frame and a reflector is different and the remaining configurations are the same as those in the first embodiment. Consequently, when describing the fourth embodiment, the same reference numerals will be given to configurations overlapping with the first embodiment, and detailed descriptions thereof will be omitted.

Referring to FIG. 8, a lighting device 1 according to the fourth embodiment includes a frame 10. The frame 10 may be formed in a truncated cone shape. The frame 10 may be formed of a metallic material. The frame 10 may include an Al-based material. The frame 10 may include an Fe-based material. The frame 10 may be a mold or a framework forming a body of the lighting device 1.

The reflector 20 may be attached to the frame 10. The reflector 20 may be attached to an inner side of the frame 10. The reflector 20 may be formed in the same shape as that of the inner side of the frame 10. The frame 10 may substitute for the metallic layer that serves as a mold of the reflector 20 in the first embodiment. That is, the metallic layer may be omitted in the reflector 20 according to the fourth embodiment.

Since the frame 10 serves as the mold of the reflector 20 so that the metallic layer may be omitted, manufacturing costs may be reduced. Also, since the reflector 20 is attached to the frame 10 by being formed in the same shape as that of the inner side of the frame 10, the reflector 20 may be prevented from deviating from the frame 10 due to an external impact.

Also, the reflector 20 may be formed by applying a reflective material onto the frame 10.

The supporter 30 may include a metallic material. The supporter 30 may include an Al-based or Fe-based metallic material. Because the supporter 30 is formed of a metallic material having high thermal conductivity, the supporter 30 may receive heat generated from the light source 40 and easily dissipate the heat to the outside.

An adhesive 39 may be disposed between the frame 10 and the supporter 30. That is, the frame 10 may be adhered to the supporter 30 by the adhesive 39. The adhesive 39 may be a material having high thermal conductivity.

The frame 10 and the supporter 30 may be adhered to each other by spot welding. The adhesive 39 may be an area at which the frame 10 and the supporter 30 are adhered to each other by spot welding.

Because the adhesive 39 is formed of a material having high thermal conductivity, heat transmitted from the light source 40 to the supporter 30 may be rapidly transmitted to the frame 10 and easily dissipated to the outside.

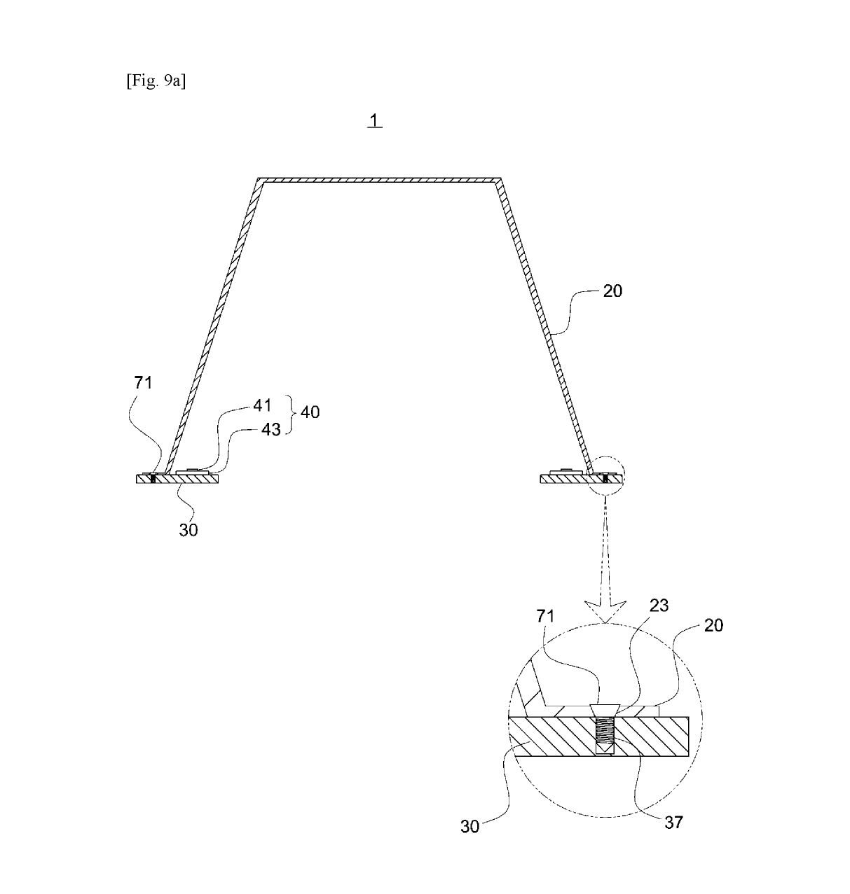

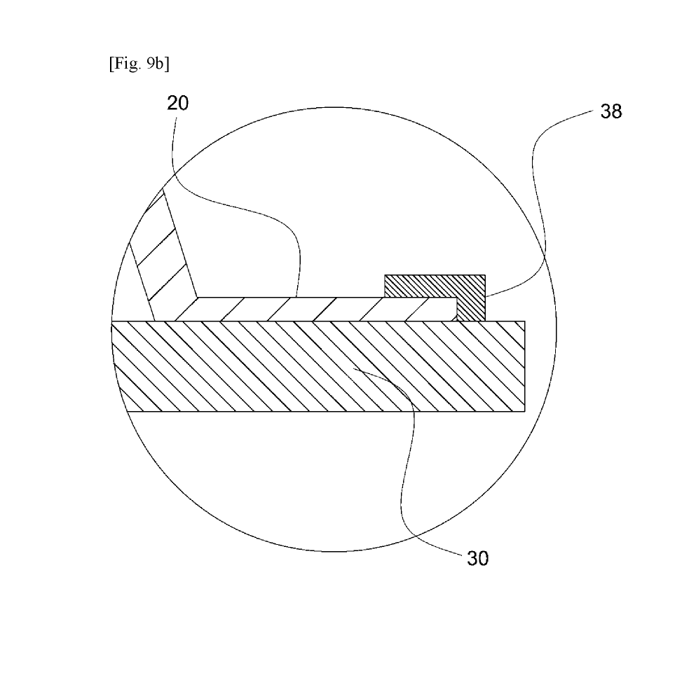

FIGS. 9A and 9B are cross-sectional views illustrating a lighting device according to a fifth embodiment.

The fifth embodiment is the same as the first embodiment except that a frame is omitted and a reflector is fixed to a supporter. Consequently, when describing the fifth embodiment, the same reference numerals will be given to configurations overlapping with the first embodiment, and detailed descriptions thereof will be omitted.

Referring to FIG. 9A, a lighting device 1 according to the fifth embodiment may include the reflector 20 and the supporter 30.

The reflector 20 may be fixed to the supporter 30. The first end of the reflector 20 may extend in a direction parallel to the supporter 30. That is, the first end of the reflector 20 may include a parallel area that is parallel to the supporter 30. The parallel area may be formed by extending in a direction opposite from the outputting area 50. The reflector 20 and the parallel area of the reflector may be integrally formed.

The first end of the reflector 20 may come into contact with an upper surface of the supporter 30. The parallel area of the reflector 20 may come into contact with the upper surface of the supporter 30. A lower surface of the parallel area of the reflector 20 may come into contact with the upper surface of the supporter 30. A first fixing hole 23 may be formed at the parallel area of the reflector 20. The first fixing hole 23 may be formed to pass through a part of the parallel area of the reflector 20.

A second fixing hole 37 may be formed at the supporter 30. The second fixing hole 37 may be formed to be recessed from the upper surface of the supporter 30 toward a lower surface of the supporter 30. Alternatively, the second fixing hole 37 may be formed to pass through the supporter 30.

The first fixing hole 23 and the second fixing hole 37 may be formed at positions corresponding to each other. The first fixing hole 23 and the second fixing hole 37 may be formed in a circular shape. The first fixing hole 23 and the second fixing hole 37 may be formed to have screw threads formed at an inner side thereof.

A fixer 71 may be inserted into the first fixing hole 23 and the second fixing hole 37. The fixer 71 may pass through the first fixing hole 23 and be inserted into the second fixing hole 37. The fixer 71 may be a screw. The fixer 71 may be coupled to the screw threads of the first fixing hole 23 and the second fixing hole 37. The reflector 20 may be fixed to the supporter 30 by the fixer 71.

Since the reflector 20 is fixed to the supporter 30 using the fixer 71, a frame may be omitted. Since the frame is omitted, manufacturing costs of the lighting device 1 may be reduced, and the reflector 20 may be fixed to the supporter 30 in a simple way.

Although the reflector 20 is described in the embodiment as being fixed to the supporter 30 by the fixer 71, the reflector 20 may also be fixed to the PCB 43 by the fixer 71. That is, the reflector 20 may also be fixed to the PCB 43 by forming the second fixing hole 37 on the PCB 43. In this case, the supporter 30 may be omitted, and the manufacturing costs may be reduced.

FIG. 9B illustrates another example of fixing the reflector 20 to the supporter 30.

Referring to FIG. 9B, the reflector 20 may be fixed to the supporter 30 by a holder 38.

The holder 38 may be formed in a shape which is bent once. The holder 38 may be formed in a shape bent in a direction parallel to the supporter 30. The holder 38 may be formed in a shape bent toward the outputting area 50.

The holder 38 may be formed to protrude from the upper surface of the supporter 30. The holder 38 may include a protruding area protruding from the upper surface of the supporter 30 in a vertical direction and a bent area bent from the protruding area toward the outputting area 50.

The holder 38 may be formed by being attached to the supporter 30 or may be integrally formed with the supporter 30.

A part of the reflector 20 may be inserted into the holder 38. The parallel area of the reflector 20 may be inserted into the holder 38. The lower surface of the parallel area of the reflector 20 may come into contact with the upper surface of the supporter 30, an end of the parallel area of the reflector 20 may come into contact with the protruding area of the holder 38, and at least a part of an upper surface of the parallel area of the reflector 20 may come into contact with a lower surface of the bent area.

An adhesive may be injected into a part of the upper surface of the supporter 30 that comes into contact with the reflector 20 and may be injected between the holder 38 and the reflector 20. The adhesive may serve to firmly fix the reflector 20 to the supporter 30 and the holder 38.

Although the holder 38 is described in the embodiment as being disposed at the supporter 30, the holder 38 may also be formed at the PCB 43 so that the reflector 20 is fixed to the PCB 43. In this case, the supporter 30 may be omitted, and the manufacturing costs may be reduced.

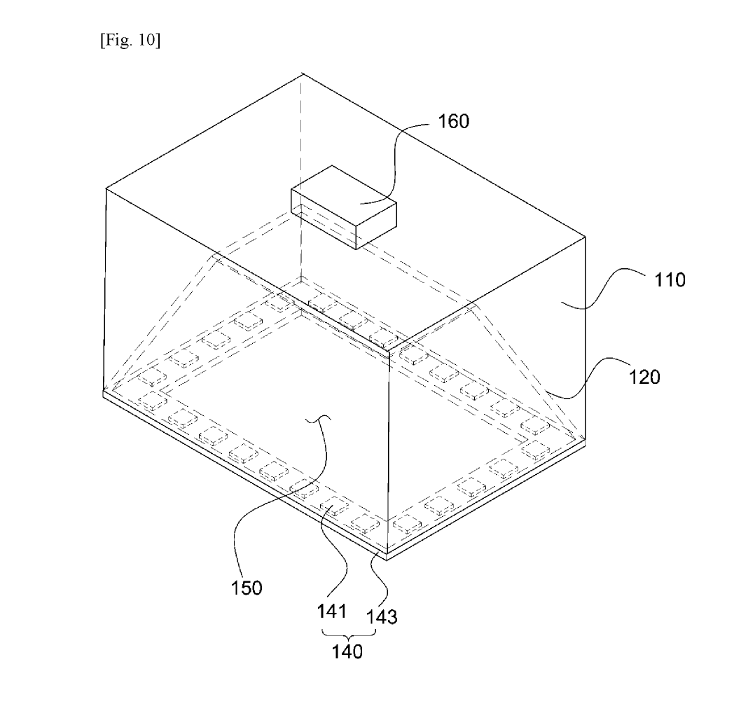

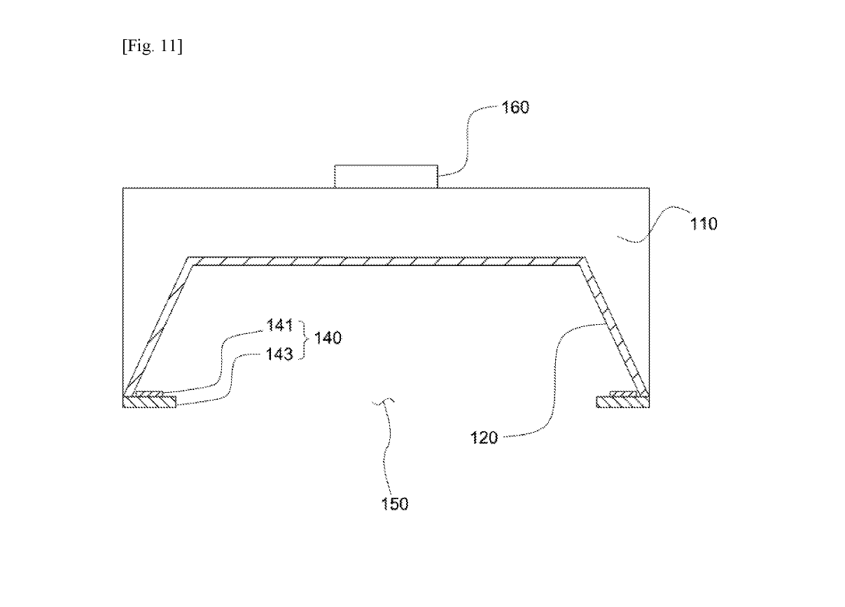

FIG. 10 is a perspective view illustrating a lighting device according to a sixth embodiment, and FIG. 11 is a cross-sectional view illustrating the lighting device according to the sixth embodiment.

Referring to FIGS. 10 and 11, the lighting device according to the sixth embodiment may include a frame 110, a reflector 120, and a light source 140.

An exterior of the frame 110 may be formed in a rectangular parallelepiped shape. The exterior of the frame 110 may be formed in a rectangular box shape. A recessed part in a quadrangular pyramid shape may be formed in the frame 110. A lower surface of the quadrangular pyramid shape may correspond to a lower surface of the frame 110, and an upper surface of the quadrangular pyramid shape may be disposed inside the frame 110.

The reflector 120 may be disposed in the recessed portion of the frame 110. The reflector 120 may be attached to the recessed portion of the frame 110.

The reflector 120 may be formed in a shape corresponding to that of the recessed portion of the frame 110. The reflector 120 may be formed in a quadrangular pyramid shape.

The light source 140 may be formed along a first end of the reflector 120. Since the first end of the reflector 120 is the lower surface of the quadrangular pyramid shape, the light source 140 may be formed along a circumference of a rectangle. The light source 140 may be arranged in a quadrangular band shape.

An outputting area 150 may be defined by the quadrangular band shape of the light source 140. That is, the light source 140 may be formed along a circumference of the outputting area 150. Since the light source 140 is arranged in the quadrangular band shape, the outputting area 150 may be defined in a rectangular shape.

The light source 140 may include a plurality of LEDs 141 and a PCB 143. Although the drawing illustrates the plurality of LEDs 141 as being disposed at a single PCB 143 in a quadrangular band shape, the plurality of LEDs 141 may also be disposed at each of a plurality of PCBs 143. Since the LEDs 141 are arranged in the quadrangular band shape, uniformity of light output through the outputting area 150 in the rectangular shape may be improved. That is, since the LEDs 141 are arranged in the quadrangular band shape, uniform light may be output without the light deviating at each side of the outputting area 150.

A power supply 160 may be disposed above the frame 110. The power supply 160 may be electrically connected to the PCB 143 via a power supply wire that is not illustrated. The power supply 160 may be formed by being recessed inside the frame 110 or may be formed by being mounted in the form of a chip on the PCB 143.

A reflection area of the reflector 120 may become smaller from the first end of the reflector 120 adjacent to the light source 140 to a second end of the reflector 120. Because the reflector 120 has a reflection area that becomes smaller from the first end adjacent to the light source 140 to the second end spaced apart from the light source 140, light is output through the outputting area 150 by being condensed at a predetermined portion. Also, the outputting area 150 may output uniform light due to a change in the reflection area.

Although configurations and features of the present invention have been described above based on embodiments according to the present invention, the present invention is not limited thereto. It should be apparent to those of ordinary skill in the art to which the present invention pertains that the present invention may be modified and changed in various ways within the spirit and scope of the present invention. Consequently, it should be noted that such modifications and changes belong to the appended claims.

### INDUSTRIAL APPLICABILITY

According to an embodiment, a lighting device has a light source disposed at a first end of a reflector, and a reflection area of the reflector becomes larger from a second end of the reflector to the first end of the reflector, thereby preventing light from directly being output and preventing glare.

### DESCRIPTION OF REFERENCE NUMERALS

1: Lighting device
10: Frame
20: Reflector
30: Supporter
31: First protruding area
33: Second protruding area
35: Supporting area
40: Light source
41: LED
43: PCB
45: Connecting wire
50: Outputting area
60: Power supply
61: Power supply wire

1. A lighting device comprising:
a light source irradiating a light;
a reflector reflecting the light from the light source; and
a supporter supporting the light source, wherein the supporter is disposed near first end of the reflector;
wherein the light source irradiates the light to second end of the reflector,
wherein a reflection area of the reflector becomes larger from the second end of the reflector to the first end of the reflector.

2. The light device of claim 1, further comprising:
a frame being disposed outside of the reflector.

3. The light device of claim 2,
wherein a shape of reflector is corresponding to an inner side of the frame,
wherein the reflector is attached to the inner side of the frame.

4. The light device of claim 2,
wherein the reflector is formed of reflective material applied to the frame.

5. The light device of claim 2, further comprising:
a power supply supplying a power to the light source,
wherein the power supply is attached to the frame.

6. The light device of claim 1, further comprising:
a fixer fixing the reflector and the supporter.

7. The light device of claim 6, further comprising:
a first fixing hole being formed to the reflector,
a second fixing hole being formed to the supporter,
wherein the fixer is inserted to the first fixing hole and the second fixing hole.

8. The light device of claim 1, further comprising:
a holder being protruded from the supporter,
wherein the first end of the reflector is inserted to the holder.

9. The light device of claim 1,
wherein the supporter includes an opening,
wherein the opening determines an outputting area being output the light,
wherein the light source is disposed on the supporter along a circumference of the outputting area.

10. The light device of claim 1,
wherein the reflector has a truncated cone shape, a cone shape or a quadrangular pyramid shape.

11. The light device of claim 1,
wherein the supporter is formed of metallic materials.

12. The light device of claim 1,
wherein the reflector is coated with photocatalyst including titanium compounds.

13. The light device of claim 2,
wherein the supporter is attached to the frame by an adhesive.
